(19) United States
(12) Patent Application Publication
(10) Pub. No.: US 2009/0103342 A1
(43) Pub. Date: Apr. 23, 2009

(54) SILICON-CONTROLLED RECTIFIER WITH A HEAT-DISSIPATING STRUCTURE

(76) Inventor: Saul LIN, Kaohsiung Hsien (TW)

Correspondence Address: Hershkovitz & Associates, LLC, 2845 Duke Street, Alexandria, VA, 22314, US

(21) Appl. No.: 11/874,095

(22) Filed: Oct. 17, 2007

(51) Int. Cl. H02M 7/00

(52) U.S. Cl. 363/125

(57) ABSTRACT

A silicon-controlled rectifier with a heat-dissipating structure has a heat sink, a silicon-controlled rectifying assembly, an outer contact assembly, a gate-contact assembly and a clamp. The heat sink is electrically and thermally conductive and has an inner contact surface and multiple fastener holes being formed in the flat surface around the inner contact surface. The silicon-controlled rectifying assembly is mounted on the inner contact surface and has a silicon-controlled rectifying device having a gate. The outer contact assembly is mounted on the silicon-controlled rectifying device. The gate-contact assembly is mounted against the gate of the silicon-controlled rectifying device. The clamp is mounted on the outer contact assembly and screwed to the fastener holes around the inner contact surface of the heat sink, connects to the heat sink and holds the outer contact assembly and the silicon-controlled rectifying assembly.

### BACKGROUND OF THE INVENTION

1. Field of the Invention

The present invention relates to a silicon-controlled rectifier and more particularly to a silicon-controlled rectifier with a heat-dissipating structure.

2. Description of the Related Art

With reference to FIG. 10 and FIG. 11, a conventional SCR (2) is a device that controls current flow and comprises an isolation shell (60), a cathode-contact assembly (61), a gate-contact assembly (62), a washer (63), a silicon-controlled rectifier (64), a positioning annulus (65) and an anode-contact assembly (66).

The isolation shell (60) is hollow and cylindrical and has two opening, an inner surface and an outer surface.

The cathode-contact assembly (61) has an inner surface, a cathode-contact (611), a central hole (612) and a groove (613). The cathode-contact (611) is formed on the inner surface, is mounted in one opening of the isolation shell (60) and has an outer edge. The central hole (612) is formed in the cathode-contact (611). The groove (613) is formed in the cathode-contact (611) and communicates with the central hole (612) and the outer edge.

The gate-contact assembly (62) is mounted in the cathode-contact (611) and has a spring (621), a gate-contact (622), a tube (624) and a wire (623). The spring (621) is mounted in the central hole (612). The gate-contact (622) is mounted in the central hole (612) on the spring (621). The tube (624) is mounted through the isolation shell (60), aligns with the groove (613) in the cathode-contact assembly (61), extends from the inner surface to the outer surface of the isolation shell (60) and protrudes from the outer surface. The wire (623) connects to the gate-contact (622), is mounted in the groove (613), passes through the tube (624) of the isolation shell (60) and protrudes from the isolation shell (60).

The washer (63) is electrically conductive, is mounted on the cathode-contact (611) and has a central through hole. The central through hole corresponds to the central hole (612) in the cathode-contact (611) and exposes the gate-contact (622).

The silicon-controlled rectifier (64) is a semiconductor disk, is mounted concentrically on the washer (63) and has an outer edge, two sides, a cathodic surface (642), an anodic surface, a gate (643) and insulation (644). The cathodic surface (642) is formed on one side of the semiconductor disk and is mounted against the washer (63) and has a center. The anodic surface is formed on of the semiconductor disk opposite to the cathodic surface (642). The gate (643) is formed at the center of the cathodic surface (642), allows current to flow through the silicon-controlled rectifier (64) when a voltage is applied to the gate (643) and abuts the gate-contact (622) of the gate-contact assembly (62). The insulation (644) is formed around the outer edge of the silicon-controlled rectifier (64) to isolate the silicon-controlled rectifier (64) from the isolation shell (60) and may be an encapsulant that adheres to the silicon-controlled rectifier (64).

The positioning annulus (65) holds the anodic surface of the silicon-controlled rectifier (64) accurately in position in the isolation shell (60).

The anode-contact assembly (66) is mounted on the opening of the isolation shell (60) opposite to the cathode-contact assembly (61) and has an inner surface and an anode-contact (661). The anode-contact (661) is formed on and protrudes from the inner surface, is mounted in the opening of the isolation shell (60) and abuts the anodic surface of the silicon-controlled rectifier (64).

Conventional SCRs generate heat and have to be mounted with heat sinks to dissipate the heat. With reference to FIG. 12, a clamp (70) holds an SCR (2) between two heat sinks (80). However the structure of a conventional SCR and its heat sinks is large and cumbersome.

To overcome the shortcomings, the present invention provides a silicon-controlled rectifier with a heat dissipating structure to mitigate or obviate the aforementioned problems.

### SUMMARY OF THE INVENTION

The main objective of the invention is to provide a silicon-controlled rectifier with a heat dissipating structure that dissipates heat without having to incorporate additional heat sinks.

A silicon-controlled rectifier with a heat-dissipating structure has a heat sink, a silicon-controlled rectifying assembly, an outer contact assembly, a gate-contact assembly and a clamp. The heat sink is electrically and thermally conductive and has an inner contact surface and multiple fastener holes being formed in the flat surface around the inner contact surface. The silicon-controlled rectifying assembly is mounted on the inner contact surface and has a silicon-controlled rectifying device having a gate. The outer contact assembly is mounted on the silicon-controlled rectifying device. The gate-contact assembly is mounted against the gate of the silicon-controlled rectifying device. The clamp is mounted on the outer contact assembly and screwed to the fastener holes around the inner contact surface of the heat sink, connects to the heat sink and holds the outer contact assembly and the silicon-controlled rectifying assembly. Hence the silicon-controlled rectifier can dissipate heat by itself without having to be attached to other heat sinks.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of a silicon-controlled rectifier with a heat-dissipating structure in accordance with the present invention;

FIG. 2 is a perspective view of the silicon-controlled rectifier in FIG. 1;

FIG. 3 is a side view in partial section of the silicon-controlled rectifier in FIG. 1;

FIG. 4 is a perspective view of two silicon-controlled rectifiers in FIG. 1;

FIG. 5 is an exploded perspective view of the silicon-controlled rectifier in FIG. 1 with an additional isolation case;

FIG. 6 is a side view in partial section of the silicon-controlled rectifier in FIG. 5;

FIG. 7 is an exploded perspective view of a second embodiment of the silicon-controlled rectifier in accordance with the present invention;

FIG. 8 is a side view in partial section of the silicon-controlled rectifier in FIG. 7;

FIG. 9 is a side view in partial section of a third embodiment of the silicon-controlled rectifier in accordance with the present invention;

FIG. 10 is an exploded perspective view of a conventional silicon-controlled rectifier in accordance with the prior art;

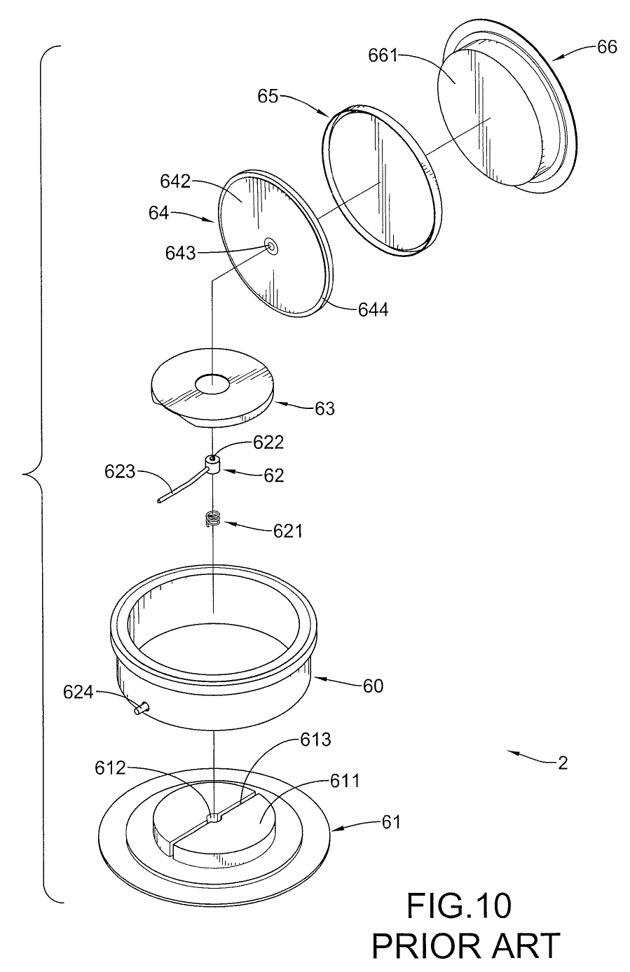

FIG. 11 is a perspective view of the conventional silicon-controlled rectifier in FIG. 10; and

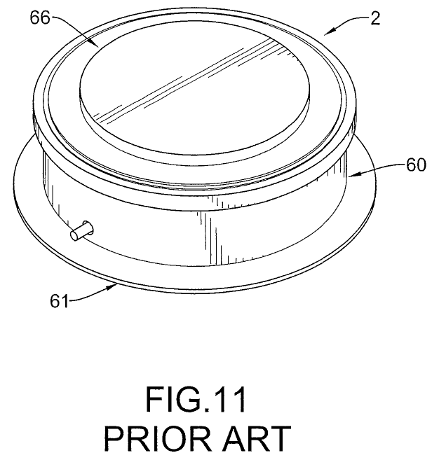

FIG. 12 is a side view of the conventional silicon-controlled rectifier with heat sinks attached.

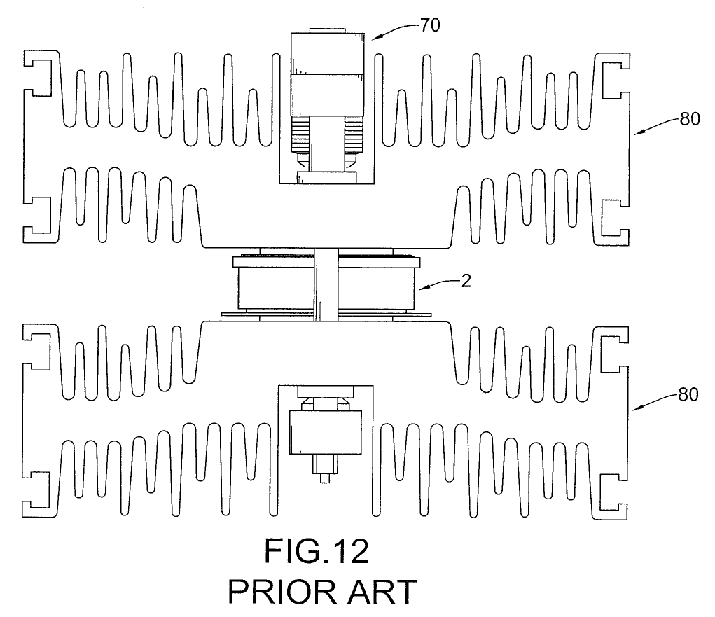

### DETAILED DESCRIPTION OF THE PREFERRED EMBODIMENTS

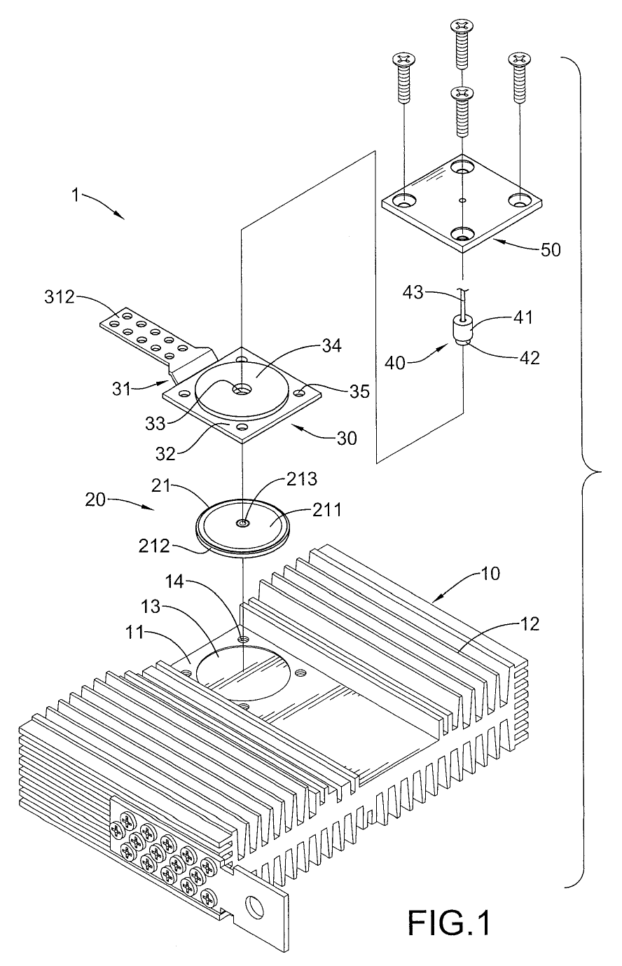

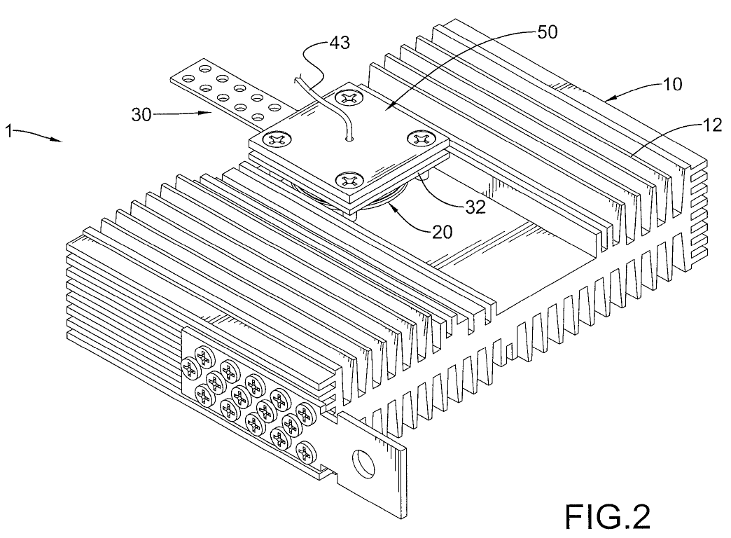

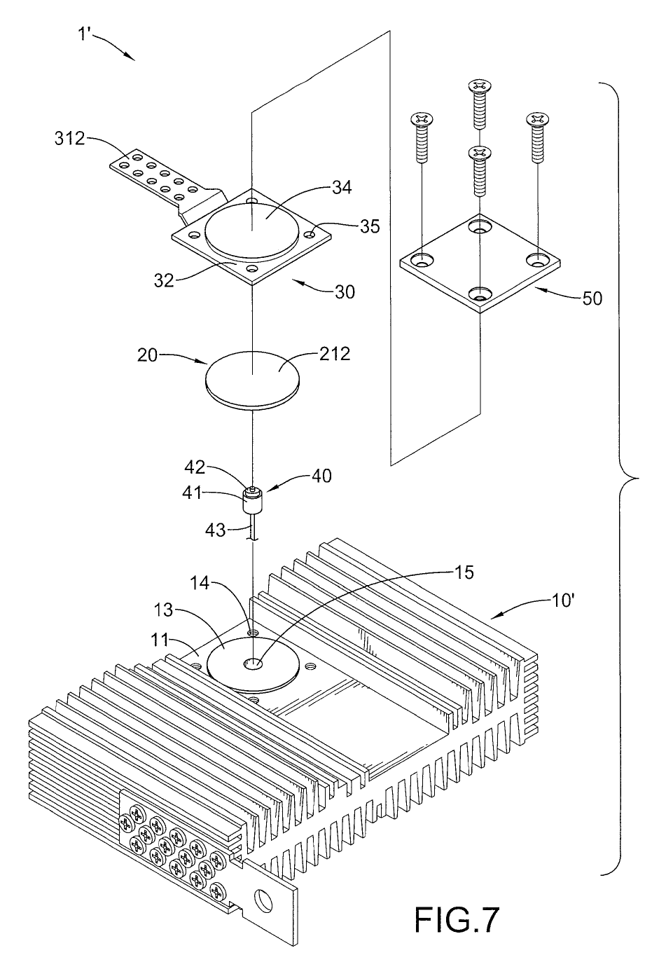

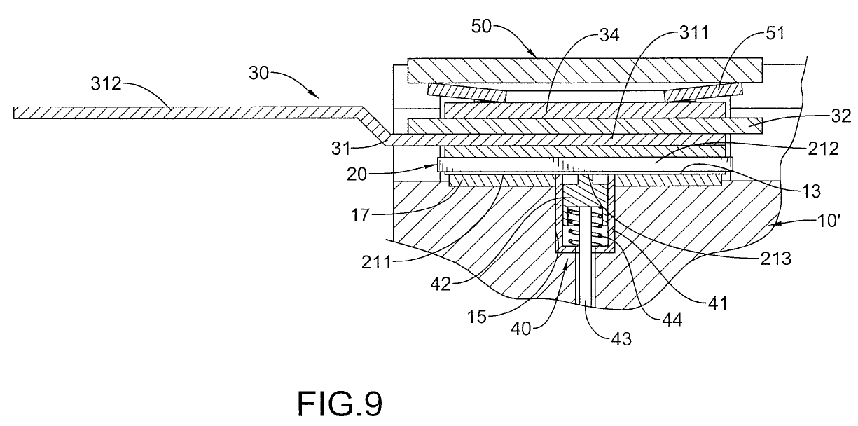

With reference to FIGS. 1, 2, 7 and 9, a silicon-controlled rectifier (1, 1′) with a heat-dissipating structure in accordance with the present invention comprises a heat sink (10, 10′), a silicon-controlled rectifying assembly (20), an outer contact assembly (30), a gate-contact assembly (40) and a clamp (50).

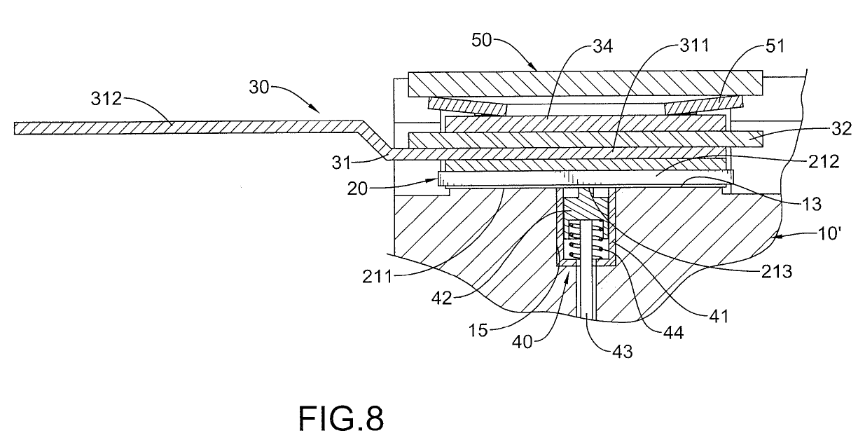

The heat sink (10, 10′) is electrically and thermally conductive and has multiple surfaces, a flat surface (11), multiple fins (12), an inner contact surface (13), an optional mounting hole (15), multiple fastener holes (14) and an optional washer (17). The flat surface (11) may have a recess. The fins (12) are formed on and protrude from the surfaces of the heat sink (10, 10′) except the flat surface (11). The inner contact surface (13) is formed on the flat surface (11), may protrudes from or be recessed in the flat surface (11) and has a center. With further reference to FIG. 8, the mounting hole (15) is formed through the center of the inner contact surface (13) and the flat surface (11) and has a lead hole. The lead hole extends through the heat sink (10′) and communicates with the mounting hole (15). The fastener holes (14) are formed in the flat surface (11) around the inner contact surface (13) and may be threaded. The washer (17) is mounted in the recess in the flat surface (11) under the inner contact surface (13).

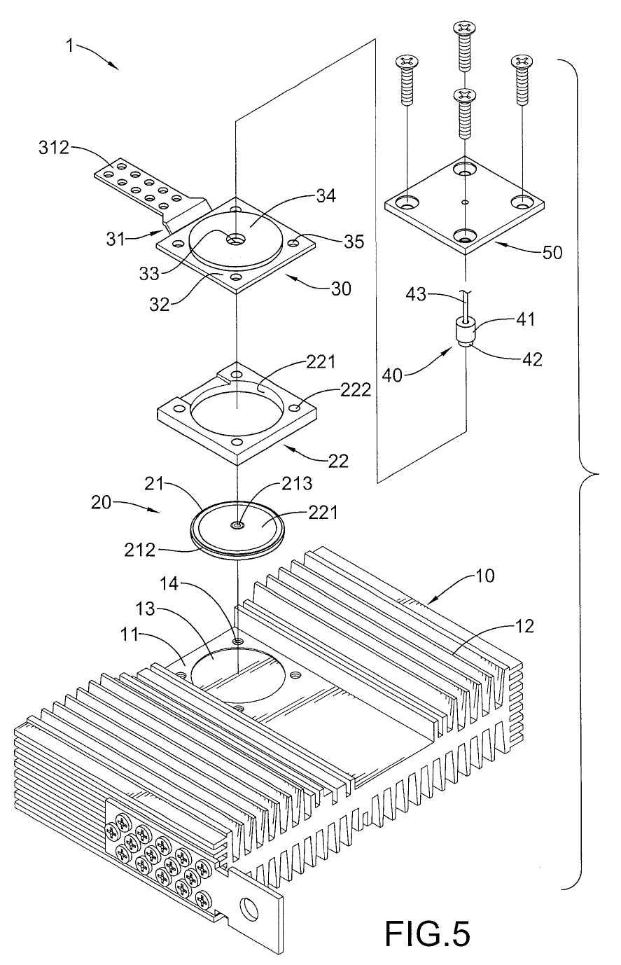

With further reference to FIG. 5, the silicon-controlled rectifying assembly (20) is mounted on the inner contact surface (13) and has a silicon-controlled rectifying device (21) and an optional isolation frame (22). The silicon-controlled rectifying device (21) has a top, a bottom, a cathodic surface (211), an anodic surface (212) and a gate (213). The cathodic surface (211) is formed on the top or the bottom of the silicon-controlled rectifying device (21), may be mounted on the protruding inner contact surface (13) and has a center. The anodic surface (212) is formed on the silicon-controlled rectifying device (21) opposite to the cathodic surface (211) and may be mounted on the inner contact surface (13). The gate (213) is formed in the center of the cathodic surface (211). The isolation frame (22) is mounted around the silicon-controlled rectifying device (21) and has a central hole (221) and multiple mounting holes (222). The central hole (221) corresponds to and is mounted around the silicon-controlled rectifying device (21) to protect and isolate the silicon-controlled rectifying device (21). The mounting holes (222) correspond to and align with the fastener holes (14) in the flat surface (13).

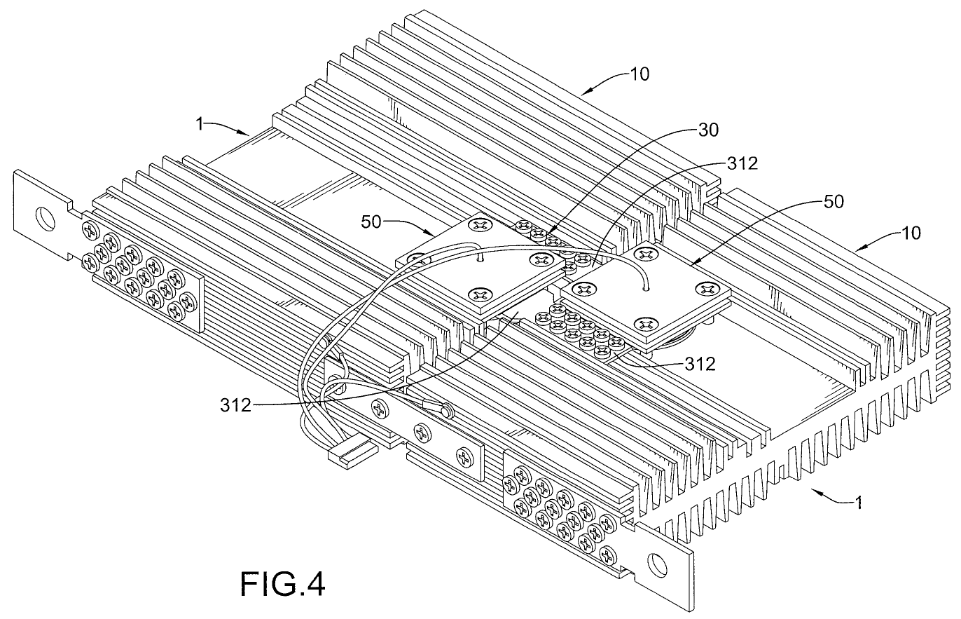

The outer contact assembly (30) is mounted on the silicon-controlled rectifying device (21) and has an electrically conductive panel (31), an insulated panel (32), an optional spacer (34) and an optional central hole (33). The electrically conductive panel (31) has an edge, a top, a bottom, a lead (312) and a contact (311). With further reference to FIG. 4, the lead (312) is formed on and extends from the edge of the electrically conductive panel (31) and allows two silicon-controlled rectifiers (1) to be connected against each other by attaching one's lead (312) to the other's heat sink (10). The contact (311) is formed on and protrudes from the bottom of the electrically conductive panel (31) and presses against the cathodic surface (211) or the anodic surface (212). The insulated panel (32) is mounted on the top of the electrically conductive panel (31) and has multiple optional mounting holes (35). The mounting holes (35) correspond to and align with the fastener holes (14) in the heat sink (10). The spacer (34) is mounted on the insulated panel (32) and keeps the insulated panel (32) and electrically conductive panel (31) from deforming. The central hole (33) is defined through the spacer (34), the insulated panel (32), the electrically conductive surface (31) and the contact (311).

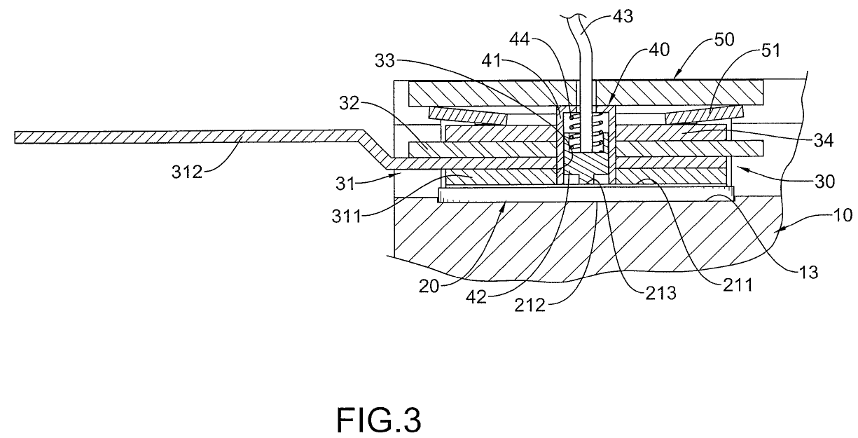

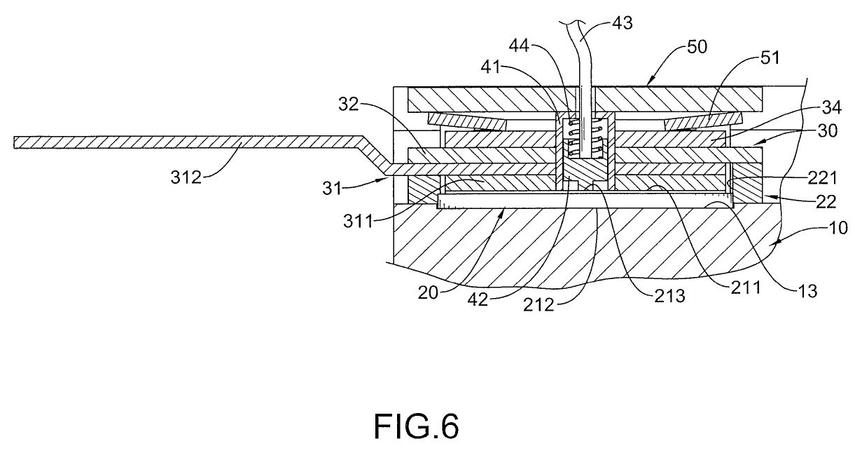

With further reference to FIGS. 3 and 6, the clamp (50) is mounted on the outer contact assembly (30), connects to the heat sink (10, 10′), holds the outer contact assembly (30) and the silicon-controlled rectifying assembly (20) and has a panel, an optional resilient washer (51) and multiple fasteners. The panel presses against the outer contact assembly (30) and has a center, an optional lead hole and multiple mounting holes. The lead hole is formed through the center of the panel. The mounting holes are formed through the panel and correspond to and align with the mounting holes (35) in the insulated panel (32) and the fastener holes (14) in the heat sink (10, 10′). The resilient washer (51) is mounted between the panel of the clamp (50) and the spacer (34) of the outer contact assembly (30) to equalize pressure applied by the panel of the clamp (50). The fasteners extend respectively through the mounting holes in the panel of the clamp (50) and the mounting holes (35) of the insulated panel (32), attach respectively to the fastener holes (14) of the heat sink (10, 10′) and may be bolts, screws, rivets or the like.

The gate-contact assembly (40) is mounted against the gate (213) of the silicon-controlled rectifying device (21), is mounted in the central hole (33) of the outer contact assembly (30) or the mounting hole (15) in the heat sink (10′) and has an insulated housing (41), a contact (42), a wire (43) and an optional resilient element (44). The insulated housing (41) is mounted in the central hole (33) of the outer contact assembly (30) or the mounting hole (15) in the heat sink (10′) and has a closed end and an open end. The closed end has a central through hole. The contact (42) is mounted inside the insulated housing (41) and has an inner end and an outer end. The outer end protrudes through the open end of the insulated housing (41) and presses against the gate (23) of the silicon-controlled rectifying device (21). The wire (43) connects to the inner end of the contact (42), passes through the central through hole in the closed end of the insulated housing (41) and extends through the lead hole in the panel of the clamp (50) or the lead hole in the head sink (10′). The resilient element (44) is mounted in the insulated housing (41) around the wire (43) between the contact (42) and the closed end of the insulated housing (41) and may be a spring.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A silicon-controlled rectifier with a heat-dissipating structure comprising
a heat sink being electrically and thermally conductive and having
multiple surfaces;
a flat surface;
multiple fins being formed on and protruding from the surfaces of the heat sink except the flat surface;
an inner contact surface being formed on the flat surface and having a center; and
multiple fastener holes being formed in the flat surface around the inner contact surface;
a silicon-controlled rectifying assembly being mounted on the inner contact surface and having a silicon-controlled rectifying device having
a top;
a bottom;
a cathodic surface being formed on the top or the bottom of the silicon-controlled rectifying device and having a center;
an anodic surface being formed on the silicon-controlled rectifying device opposite to the cathodic surface; and
a gate being formed in the center of the cathodic surface;
a outer contact assembly being mounted on the silicon-controlled rectifying device and having
an electrically conductive surface having
an edge;
a top;
a bottom;
a lead being formed on and extending from the edge of the electrically conductive panel; and
a contact being formed on and protruding from the bottom of the electrically conductive panel; and
an insulated panel being mounted on the top of the electrically conductive panel;
a gate-contact assembly being mounted against the gate of the silicon-controlled rectifying device and having
an insulated housing having
a closed end having a central through hole; and
an open end;
a contact being mounted slidably inside the insulated housing and having
an inner end; and
an outer end protruding through the open end of the insulated housing and pressing against the gate of the silicon-controlled rectifying device; and
a wire connecting to the inner end of the contact and passing through the central through hole in the closed end of the insulated housing; and
a clamp being mounted on the outer contact assembly and screwed to the fastener holes around the inner contact surface of the heat sink, connecting to the heat sink, holding the outer contact assembly and the silicon-controlled rectifying assembly and having
a panel pressing against the outer contact assembly and having
a center; and
multiple mounting holes being formed through the panel and corresponding to and aligning with the fastener holes in the heat sink; and
multiple fasteners extending respectively through the mounting holes in the panel of the clamp and attaching respectively to the fastener holes of the heat sink.

2. The silicon-controlled rectifier as claimed in claim 1, wherein
the inner contact surface is recessed in the flat surface;
the anodic surface is mounted on the inner contact surface;
the outer contact assembly further has
a spacer being mounted on the insulated panel; and
an central hole being formed through the spacer, the insulated panel, the electrically conductive surface and the contact;
the contact of the outer contact assembly presses against the cathodic surface;
the clamp further has a lead hole being formed through the center of the panel;
the gate-contact assembly is mounted in the central hole of the outer contact assembly;
the insulated housing is mounted in the central hole of the outer contact assembly; and
the wire extends through the lead hole in the panel of the clamp.

3. The silicon-controlled rectifier as claimed in claim 1, wherein
the flat surface of the heat sink further has a recess;
the inner contact surface protrudes from the flat surface;
the heat sink further has
a mounting hole being formed through the center of the inner contact surface and the flat surface and having a lead hole extending through the heat sink and communicating with the mounting hole; and
a washer being mounted in the recess in the flat surface under the inner contact surface;
the cathodic surface is mounted on the inner contact surface;
the outer contact assembly further has a spacer being mounted on the insulated panel;
the contact of the outer contact assembly presses against the anodic surface;
the gate-contact assembly is mounted in the mounting hole in the heat sink;
the insulated housing is mounted in the mounting hole in the heat sink; and
the wire of the gate-contact assembly extends through the lead hole in the head sink.

4. The silicon-controlled rectifier as claimed in claim 1, wherein
the silicon-controlled rectifying assembly further has an isolation frame being mounted around the silicon-controlled rectifying device and having
a central hole corresponding to and being mounted around the silicon-controlled rectifying device to protect and isolate the silicon-controlled rectifying device; and
multiple mounting holes corresponding to and aligning with the fastener holes in the flat surface; and
the fasteners of the clamp extend respectively through the mounting holes in the isolation frame.

5. The silicon-controlled rectifier as claimed in claim 1, wherein the fastener holes of the heat sink are threaded.

6. The silicon-controlled rectifier as claimed in claim 1, wherein the insulated panel of the outer contact assembly further has multiple mounting holes corresponding to and aligning with the fastener holes in the heat sink.

7. The silicon-controlled rectifier as claimed in claim 1, wherein the gate-contact assembly further has a resilient element being mounted in the insulated housing around the wire between the contact and the closed end of the insulated housing.

8. The silicon-controlled rectifier as claimed in claim 1, wherein the fasteners of the clamp are bolts.

9. The silicon-controlled rectifier as claimed in claim 1, wherein the fasteners of the clamp are screws.

10. The silicon-controlled rectifier as claimed in claim 1, wherein the fasteners of the clamp are rivets.

11. The silicon-controlled rectifier as claimed in claim 1, wherein the clamp further has a resilient washer being mounted between the panel of the clamp and the outer contact assembly.

12. The silicon-controlled rectifier as claimed in claim 6, wherein the mounting holes of the clamp correspond to and align with the mounting holes in the insulated panel.

13. The silicon-controlled rectifier as claimed in claim 6, wherein the fasteners of the clamp extend respectively through the mounting holes of the insulated panel.
